(19) United States
(12) Patent Application Publication
(10) Pub. No.: US 2018/0096470 A1
(43) Pub. Date: Apr. 5, 2018

(54) IMAGE PROCESSING DEVICE, IMAGE PROCESSING METHOD, AND NON-TRANSITORY COMPUTER-READABLE MEDIUM STORING IMAGE PROCESSING PROGRAM

(71) Applicant: OLYMPUS CORPORATION, Tokyo (JP)

(72) Inventor: Hisumi ESAKI, Kanagawa (JP)

(73) Assignee: OLYMPUS CORPORATION, Tokyo (JP)

(21) Appl. No.: 15/831,756

(22) Filed: Dec. 5, 2017

Related U.S. Application Data
(63) Continuation of application No. PCT/JP2015/069322, filed on Jul. 3, 2015.

(51) Int. Cl. G06T 5/20

(52) U.S. Cl. CPC G06T 5/20; G06T 2207/20192; G09G 2320/0233

(57) ABSTRACT

Provided is an image processing device including: a difference-value calculating unit that calculates, with respect to an input image, a difference value for each pixel based on a pixel of interest and surrounding pixels surrounding the pixel of interest serving as the center; a reference-value calculating unit that calculates a reference value that serves as a reference used when an intensity value for each pixel of the input image is calculated, based on the average value of the difference values; an intensity-correction-expression generating unit that generates an intensity correction expression for calculating the intensity value, by using the reference value; an intensity-value calculating unit that calculates the intensity value for each pixel based on the intensity correction expression; and a compositing unit that generates a composited image by adding the intensity values to pixel values of corresponding pixels of the input image.

### CROSS-REFERENCE TO RELATED APPLICATIONS

This is a continuation of International Application PCT/JP2015/69322, with an international filing date of Jul. 3, 2015, which is hereby incorporated by reference herein in its entirety.

### TECHNICAL FIELD

The present invention relates to an image processing device, an image processing method, and an image processing program and, in particular, to an image processing device, an image processing method, and an image processing program for performing edge enhancement.

### BACKGROUND ART

In the related art, various image processing devices that improve image quality by performing so-called edge enhancement processing, in which contour components of an image are enhanced, have been proposed.

For example, PTL 1 discloses an image processing device in which a predetermined correction curve corresponding to contrast is applied to images acquired in different frequency bands, thus performing gain adjustment, and processing results for the images in the respective frequency bands are integrated, thus performing edge enhancement processing.

### CITATION LIST

### Patent Literature

{PTL 1} Japanese Unexamined Patent Application, Publication No. 2014-110624

### SUMMARY OF INVENTION

According to one aspect, the present invention provides an image processing device including: a difference-value calculating means that calculates, with respect to an input image, a difference value for each pixel on the basis of a pixel of interest and surrounding pixels surrounding the pixel of interest serving as the center; a reference-value calculating means that calculates a reference value that serves as a reference used when an intensity value for each pixel of the input image is calculated, on the basis of the average value of the difference values; an intensity-correction-expression generating means that generates an intensity correction expression for calculating the intensity value, by using the reference value; an intensity-value calculating means that calculates an intensity value for each pixel on the basis of the intensity correction expression; and a compositing means that generates a composited image by adding the intensity values to the pixel values of the corresponding pixels of the input image.

Furthermore, according to another aspect, the present invention provides an image processing method including: a difference-value calculating step of calculating, with respect to an input image, a difference value for each pixel on the basis of a pixel of interest and surrounding pixels surrounding the pixel of interest serving as the center; a reference-value calculating step of calculating a reference value that serves as a reference used when an intensity value for each pixel of the input image is calculated, on the basis of the average value of the difference values; an intensity-correction-expression generating step of generating an intensity correction expression for calculating the intensity value, by using the reference value; an intensity-value calculating step of calculating the intensity value for each pixel on the basis of the intensity correction expression; and a compositing step of generating a composited image by adding the intensity values to the pixel values of the corresponding pixels of the input image.

Furthermore, according to still another aspect, the present invention provides an image processing program for causing a computer to execute: a difference-value calculating step of calculating, with respect to an input image, a difference value for each pixel on the basis of a pixel of interest and surrounding pixels surrounding the pixel of interest serving as the center; a reference-value calculating step of calculating a reference value that serves as a reference used when an intensity value for each pixel of the input image is calculated, on the basis of the average value of the difference values; an intensity-correction-expression generating step of generating an intensity correction expression for calculating the intensity value, by using the reference value; an intensity-value calculating step of calculating the intensity value for each pixel on the basis of the intensity correction expression; and a compositing step of generating a composited image by adding the intensity values to the pixel values of the corresponding pixels of the input image.

### BRIEF DESCRIPTION OF DRAWINGS

FIG. 1 is a block diagram showing, in outline, the configuration of an image processing device according to one embodiment of the present invention.

FIG. 2 is a view showing an example Sobel filter used in a difference-value calculating unit of the image processing device according to the one embodiment of the present invention.

FIG. 3 is a view showing an example Sobel filter used in the difference-value calculating unit of the image processing device according to the one embodiment of the present invention.

FIG. 4 is an intensity-value correction graph that is obtained by an intensity-correction-expression generating unit of the image processing device according to the one embodiment of the present invention, and in which the horizontal axis indicates the difference value, and the vertical axis indicates the weighting coefficient.

FIG. 5A is an example graph regarding intensity correction.

FIG. 5B is an example graph regarding intensity correction.

FIG. 5C is an example graph regarding intensity correction.

FIG. 5D is an example graph regarding intensity correction.

FIG. 5E is an example graph regarding intensity correction.

FIG. 5F is an example graph regarding intensity correction.

FIG. 6 is an example graph regarding intensity correction when the reference value has a positive or negative value.

FIG. 7 is a flowchart showing edge enhancement processing performed in the image processing device according to the one embodiment of the present invention.

FIG. 8 is a block diagram showing, in outline, the configuration of Modification 1 of the image processing device according to the one embodiment of the present invention.

FIG. 9 is a block diagram showing, in outline, the configuration of Modification 2 of the image processing device according to the one embodiment of the present invention.

### DESCRIPTION OF EMBODIMENT

An image processing device according to one embodiment of the present invention will be described below with reference to the drawings.

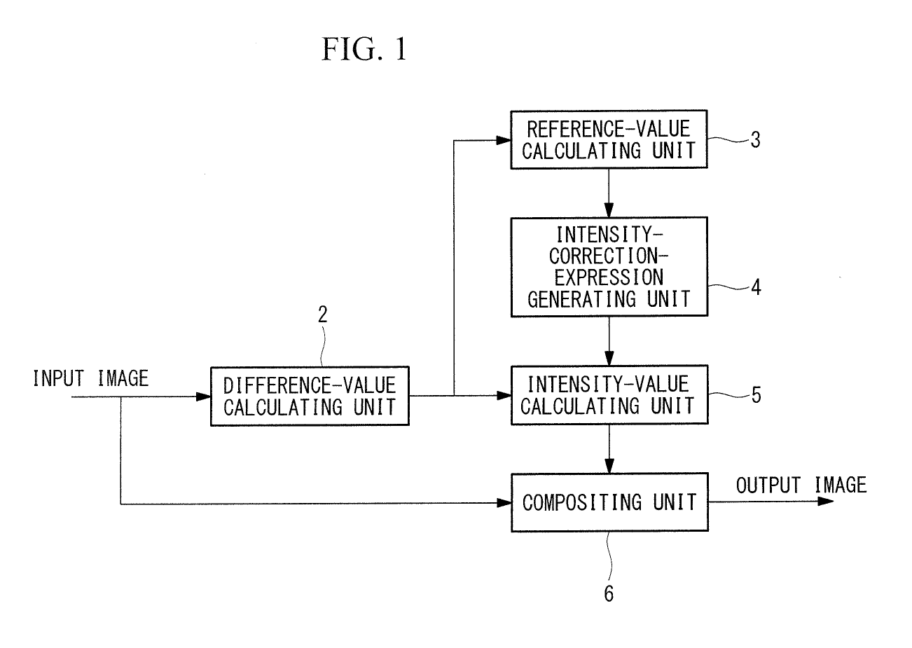

As shown in FIG. 1, the image processing device is provided with a difference-value calculating unit 2, a reference-value calculating unit 3, an intensity-correction-expression generating unit 4, an intensity-value calculating unit 5, and a compositing unit 6.

The difference-value calculating unit 2 calculates, with respect to an input image, the difference value for each pixel on the basis of a pixel of interest and surrounding pixels surrounding the pixel of interest serving as the center.

When the difference values are obtained for an input image, the difference-value calculating unit 2 can calculate the difference value for each pixel by using Sobel filters, for example.

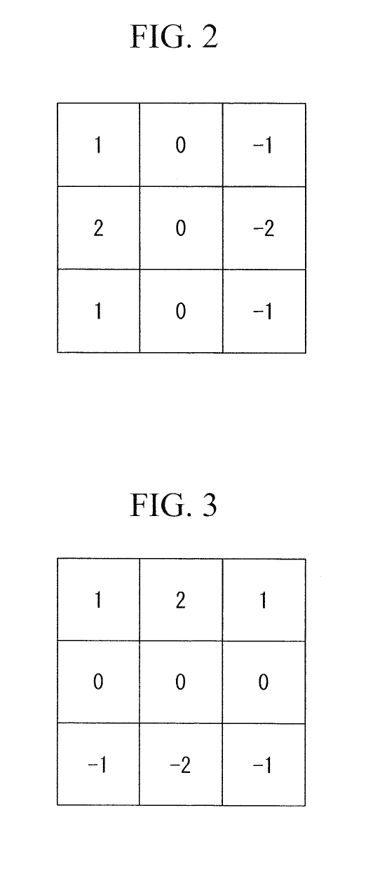

FIGS. 2 and 3 show example Sobel filters. In FIGS. 2 and 3, the differences in the vertical direction and in the horizontal direction are calculated with respect to the pixel of interest, according to the following mathematical expressions (1) and (2), in which filter_H(p,q) is used for vertical elements and filter_V(p,q) is used for horizontal elements of a Sobel filter of 3 pixels×3 pixels.

Then, in the expressions, the value that is greater, in terms of absolute value, between the results is set as Edge(x,y). Edge(x,y) has a plus or minus sign. Ks represents a kernel area, and, in this embodiment, Ks is an area of 3 pixels×3 pixels including the pixel of interest, as shown in FIGS. 2 and 3.

Sobel_H(x,y)=Σ_{(p,q)∈K}_{ₛ} In(x+p,y+q)×filter_H(p,q) (1)

Sobel_V(x,y)=Σ_{(p,q)∈K}_{ₛ} In(x+p,y+q)×filter_V(p,q) (2)

Then, the value that is greater, in terms of absolute value, between Sobel_H(x,y) and Sobel_V(x,y), which are calculated with respect to the pixel of interest, is set as the difference value Edge(x,y) according to the following mathematical expression (3). The difference value Edge(x,y) has a plus or minus sign.

$$\{ \begin{matrix}Edge ( x , y ) = Sobel\_H ( x , y ) & ( \vert Sobel\_H ( x , y ) \vert > \vert Sobel\_V ( x , y ) \vert ) \\ Edge ( x , y ) = Sobel\_V ( x , y ) & ( \vert Sobel\_H ( x , y ) \vert < \vert Sobel\_V ( x , y ) \vert )\end{matrix} \qquad ( 3 )$$

Note that the Sobel filters are not limited to the examples shown in FIGS. 2 and 3, and it is also possible to use Sobel filters that have different coefficients in filter_V(p,q) and filter_H(p,q) or Sobel filters that have a different filter size.

Furthermore, the difference-value calculating unit 2 can also calculate the difference value by using a low-cut filter, as shown in the following mathematical expression. The average value Ave(x,y) in Ks is calculated according to mathematical expression (4), and Ave(x,y), which is a low-frequency component, is subtracted from an input image In(x,y) according to mathematical expression (5), thereby making it possible to obtain the signed difference value Edge(x,y) that contains a high-frequency component.

Ave(x,y)=Σ_{(p,q)∈K}_{ₛ} In(x+p,y+q) (4)

Edge(x,y)=In(x,y)−Ave(x,y) (5)

The reference-value calculating unit 3 calculates a reference value that serves as a reference used when the intensity value for each pixel of the input image is calculated, on the basis of the average value of the difference values calculated in the difference-value calculating unit 2.

Specifically, the average value of the difference values calculated in the difference-value calculating unit 2 can be set as the reference value. Alternatively, the reference value can be a value greater than the average value by a value determined in advance.

Furthermore, if ISO sensitivity information when the input image is acquired is obtained together with this input image, and if the ISO sensitivity information shows a value lower than ISO 100, for example, it is preferred that correction be performed such that a value less than the average value is set as the reference value.

Alternatively, it is preferred that correction be performed such that a value less than the average value is set as the reference value when the amount of noise in an input image or the amount of noise in a predetermined area of an input image is less than a predetermined threshold, or such that a value greater than the average value is set as the reference value when the amount of noise in an input image or the amount of noise in a predetermined area of an input image is greater than the predetermined threshold.

Furthermore, it is preferred that correction be performed such that a value less than the average value is set as the reference value when the contrast value in an input image or the contrast value in a predetermined area of an input image is lower than a predetermined threshold, or such that a value greater than the average value is set as the reference value when the contrast value in an input image or the contrast value in a predetermined area of an input image is higher than the predetermined threshold.

The intensity-correction-expression generating unit 4 generates an intensity correction expression for calculating an intensity value, by using the reference value, which is calculated in the reference-value calculating unit. Specifically, an intensity correction expression is generated by applying the reference value calculated in the reference-value calculating unit to a graph or an expression stored in the intensity-correction-expression generating unit 4 or a storage unit (not shown). A description will be given below of a case in which the sign of the reference value is plus. For example, an expression regarding a normal distribution is stored in advance, and an intensity correction expression can be generated by using this expression.

Specifically, in the following mathematical expression (6), μ is set to the reference value, and σ is set to a value determined in advance.

$$f ( x ) = \frac{1}{\sqrt{2 {πσ}^{2}}} exp ( - \frac{{( x - μ )}^{2}}{2 {σ}^{2}} ) \qquad ( 6 )$$

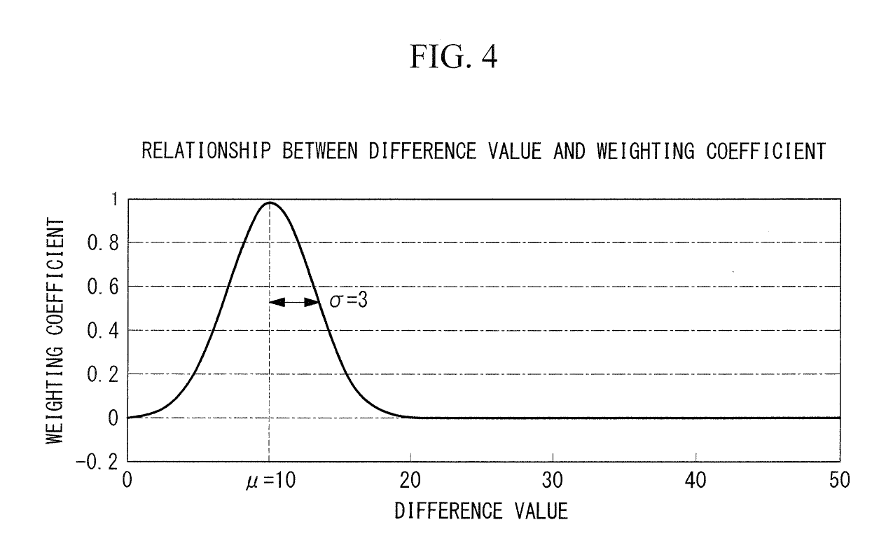

FIG. 4 shows an example case in which μ is equal to 10, and σ is equal to 3. Specifically, μ is set to 10, and σ is set to 3 in the expression of the normal distribution, thereby making it possible to generate an intensity correction expression that is an arithmetic expression for obtaining an intensity-value correction graph in which the horizontal axis indicates the difference value, and the vertical axis indicates the weighting coefficient, as shown in FIG. 4.

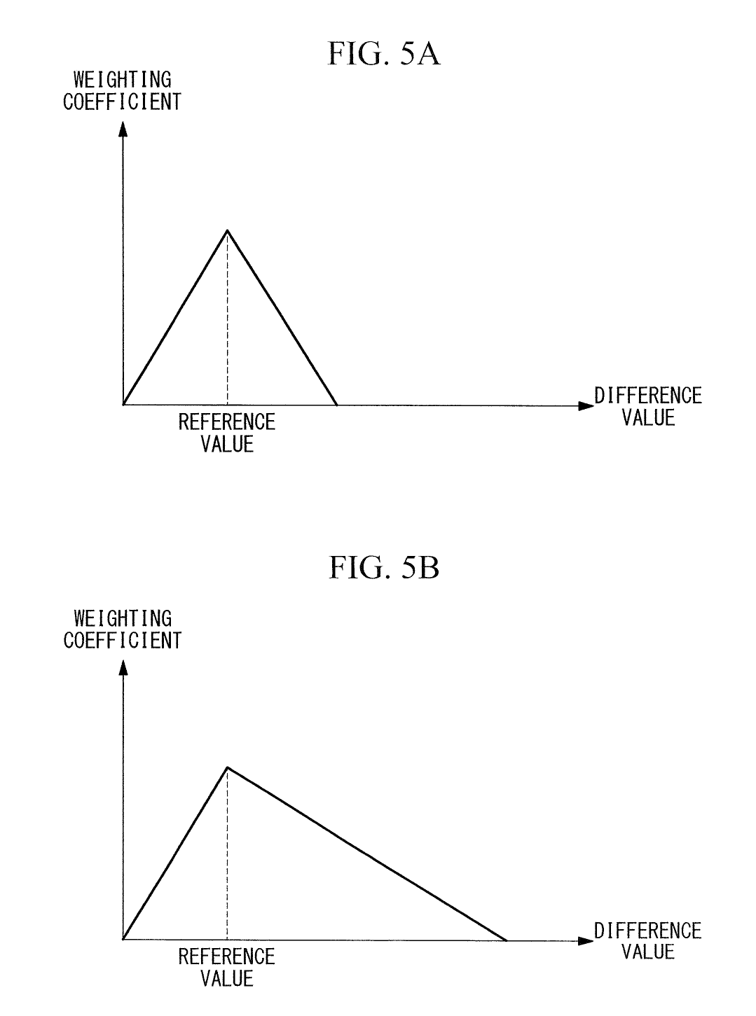

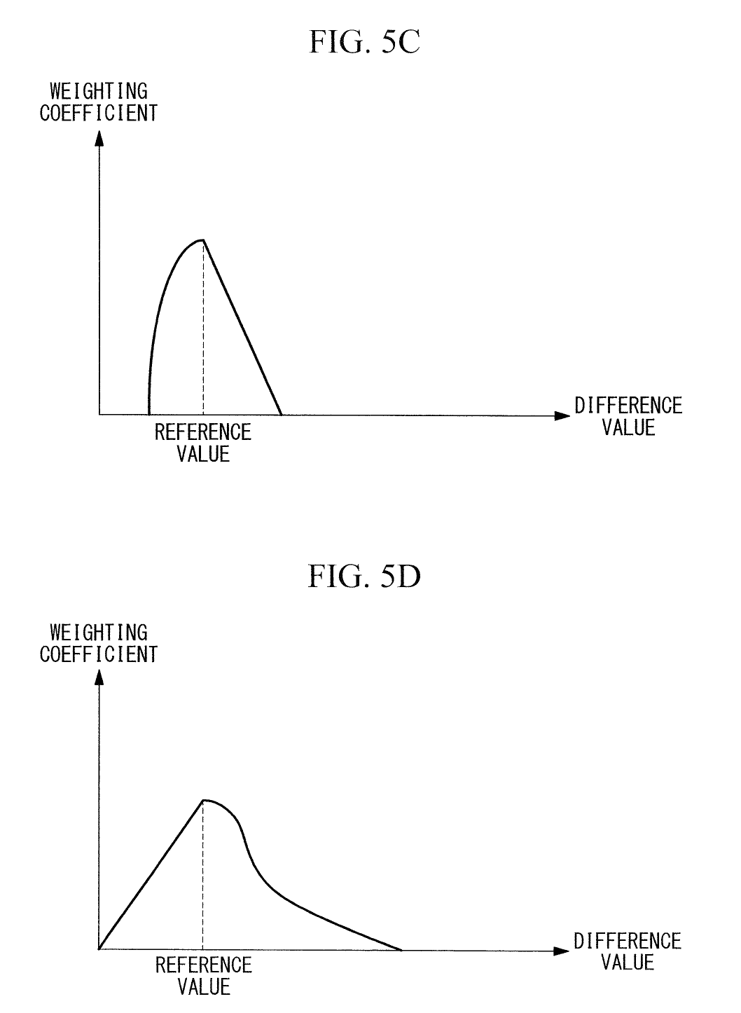

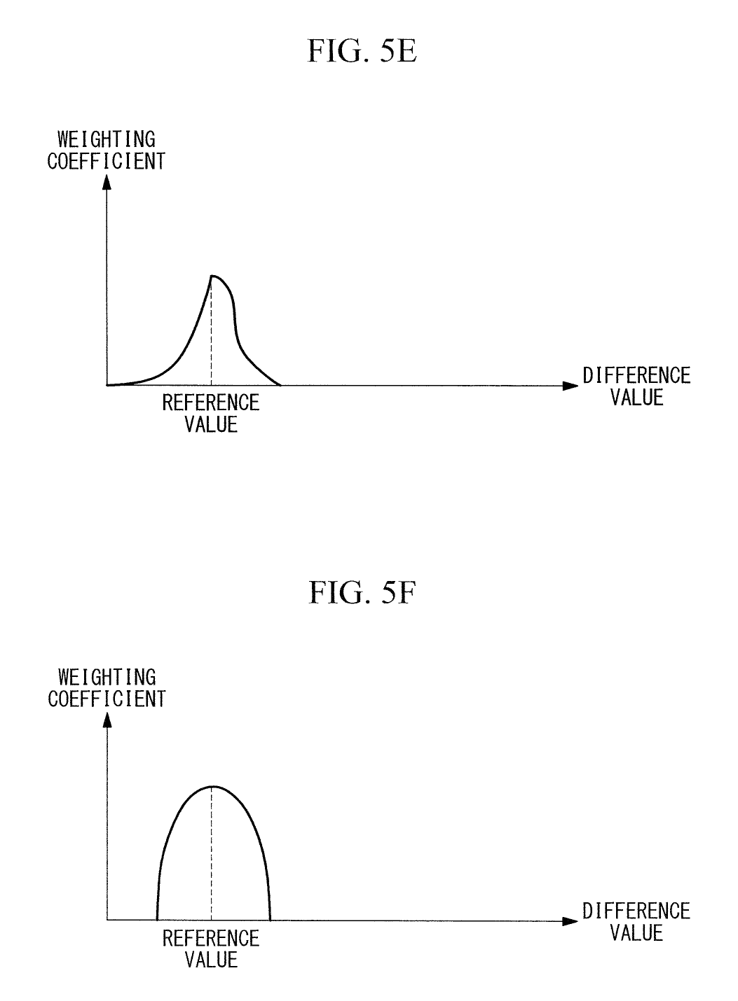

Alternatively, FIGS. 5A to 5F show other example graphs regarding intensity correction. FIG. 5A is a linear left-right symmetric graph, and FIG. 5B is a linear left-right asymmetric graph. FIG. 5C is a graph that is non-linear on the left side of the reference value in the figure and that is linear on the right side thereof in the figure. FIG. 5D is a graph that is linear on the left side in the figure and that is non-linear on the right side in the figure. FIG. 5E is a non-linear left-right asymmetric graph, and FIG. 5F is a non-linear left-right symmetric graph.

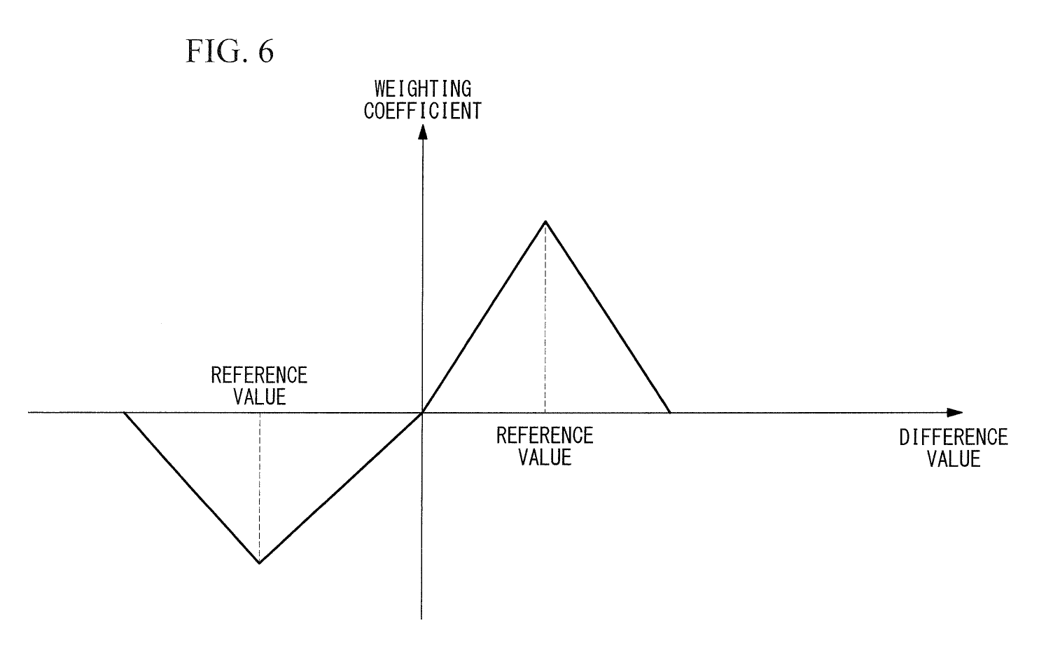

In this way, the property of an input image is grasped, the shape of an intensity-correction graph is determined, and an intensity correction expression is generated. The reference value is calculated to make it possible to set various shapes of linear/non-linear graphs on the left and right sides of the graphs, with the reference value serving as the peak in the weighting coefficient, to prevent noise or artifacts contained in low-frequency components, for example, and to suppress enhancement of high-frequency components. Note that, when the reference value has a positive or negative value, as shown in FIG. 6, it is possible to determine a shape for determining a positive weighting coefficient when the reference value is positive and a negative weighting coefficient when it is negative.

The intensity-value calculating unit 4 calculates the intensity value for each pixel on the basis of the intensity correction expression generated by the intensity-correction-expression generating unit 5.

Specifically, the difference value edge(x,y), which is obtained from the difference-value calculating unit 2, is substituted into the intensity correction expression, which is obtained from the intensity-correction-expression generating unit 4, to calculate a weighting coefficient, and an intensity value is obtained by taking the calculated weighting coefficient into consideration. However, when the difference value is negative, the absolute value thereof is used for calculation, and the sign is added after the calculation is finished. For example, an intensity-value correction expression that is obtained by setting μ to 10 and σ to 3 in mathematical expression (6) becomes mathematical expression (7). Mathematical expression (8) shows an expression for calculating the sign of the value of weight by using the sign of a difference value edge(x,y).

$$\begin{matrix}weight = \frac{1}{\sqrt{18 π}} exp ( - \frac{{( \vert edge ( x , y ) \vert - 10 )}^{2}}{18} ) & ( 7 ) \\ weight = \{ \begin{matrix}weight & ( edge ( x , y ) > 0 ) \\ weight * - 1 & ( edge ( x , y ) < 0 )\end{matrix} \} & ( 8 )\end{matrix}$$

Furthermore, the intensity-value calculating unit 5 obtains the maximum value lim_max and the minimum value lim_min of an enhancement amount determined in advance, and takes the product of the weighting coefficient weight calculated from the intensity correction expression and the lim_max when the weighting coefficient is positive or the lim_min when the weighting coefficient is negative, thus determining an intensity value Add(x,y) to be added to the input image.

$$\{ \begin{matrix}Add ( x , y ) = lim\_max weight & ( weight > 0 ) \\ Add ( x , y ) = lim\_min weight & ( weight < 0 )\end{matrix} \qquad ( 9 )$$

where, −1<weight<1.

The compositing unit 6 adds the intensity values, which are calculated in the intensity-value calculating unit 5, to the pixel values of the corresponding pixels in the input image, thereby generating a composited image.

Specifically, the intensity values Add(x,y), which are calculated in the intensity-value calculating unit 5, are added to the input image In(x,y) for the respective pixels.

out(x,y)=In(x,y)+Add(x,y) (10)

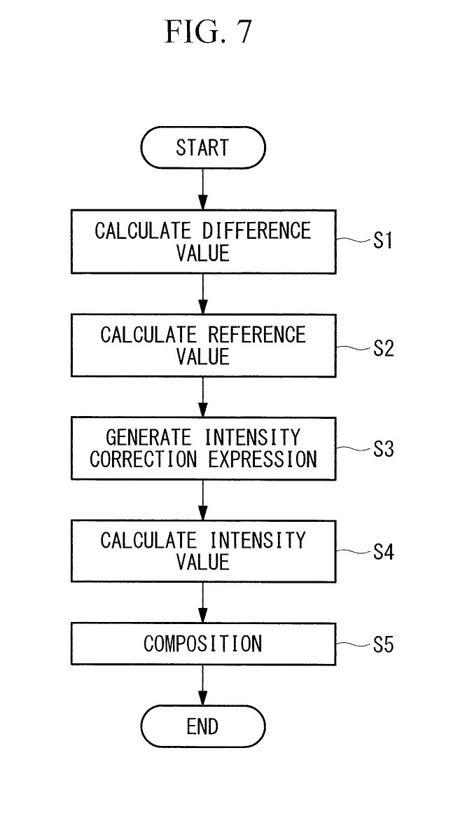

Then, an image processing method performed by the thus-configured image processing device will be described with reference to the flowchart shown in FIG. 7.

In order to perform edge enhancement processing with respect to an input image by using the image processing device of this embodiment, in Step S1, the difference-value calculating unit 2 calculates, for each pixel of interest, the difference value by applying Sobel filters of 3 pixels×3 pixels to the input image.

Then, in Step S2, the reference-value calculating unit 3 calculates the average value of the difference values and sets the average value as the reference value. Note that the reference value may be appropriately corrected by using information about the features (the amount of noise or the contrast) of the input image or the capturing environment (the image size, the ISO sensitivity, or the like).

Then, in Step S3, the intensity-correction-expression generating unit 4 uses the reference value calculated in the previous Step S2 to generate an intensity correction expression. In Step S4, the intensity-value calculating unit 5 calculates the intensity values for respective pixels of the input image on the basis of the intensity correction expression, which is generated by the intensity-correction-expression generating unit 4, and outputs the intensity values to the compositing unit 6. In Step S5, the compositing unit 6 adds the intensity values for the respective pixels in the input image and generates a composited image as an output image.

In this way, according to the image processing device of this embodiment, the difference value is calculated for each pixel of the input image, thereby determining whether the pixel of interest is an edge on the basis of the magnitude of the difference value, and determining, from the difference value, the reference value, which serves as a reference used when edge enhancement processing is performed; thus, it is possible to obtain a parameter for performing image processing suitable for the properties of the input image. Then, the intensity values calculated from the intensity correction expression, which uses this reference value, are added, for the respective pixels, to the corresponding pixel values in the input image, to generate a composited image, thereby making it possible to suppress edge discontinuities and unnatural edge enhancement and to obtain a good image in which edges are naturally enhanced.

### Modification 1

In the above-described embodiment, although an input image is directly subjected to calculations of the difference values and the reference value, the present invention is not limited thereto, and, for example, it is also possible to apply noise reduction processing etc. to an input image, to input the processed image to the difference-value calculating unit 2, and to perform processing, such as calculations of the difference values and the reference value, with respect to the processed image.

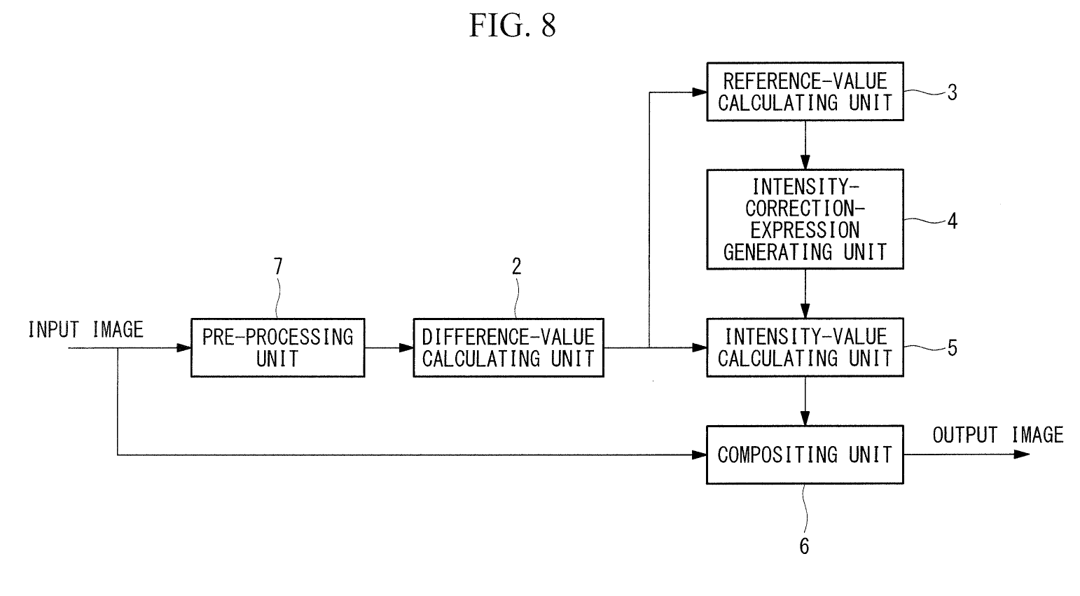

In this case, for example, as shown in FIG. 8, the image processing device can be configured to include a pre-processing unit 7 that applies, as pre-processing, at least one of noise reduction processing and gradation correction processing to an input image, and to input the image processed in the pre-processing unit to the difference-value calculating unit 2.

Since the processing of the difference-value calculating unit 2, the reference-value calculating unit 3, the intensity-correction-expression generating unit 4, the intensity-value calculating unit 5, and the compositing unit 6 is the same as the processing in the above-described image processing device, a description thereof will be omitted.

Note that the compositing unit 6 adds the intensity values to the respective pixels of the input image that has not been processed by the pre-processing unit 7, thereby generating a composited image.

In this way, an input image is subjected to pre-processing and is then subjected to processing, such as calculations of difference values etc., thereby making it possible to calculate more preferable difference values that are less affected by noise or contrast, compared with the above-described image processing device; thus, more natural edge enhancement processing can be performed.

### Modification 2

In the above-described embodiment, although an input image is directly subjected to calculations of the difference values and the reference value, the present invention is not limited thereto, and, for example, low-pass-filter processing is applied to an input image, and the difference-value calculating unit 2 calculates the differences between the input image and an image that is obtained by applying the low-pass-filter processing to the input image, thereby making it possible to calculate difference values.

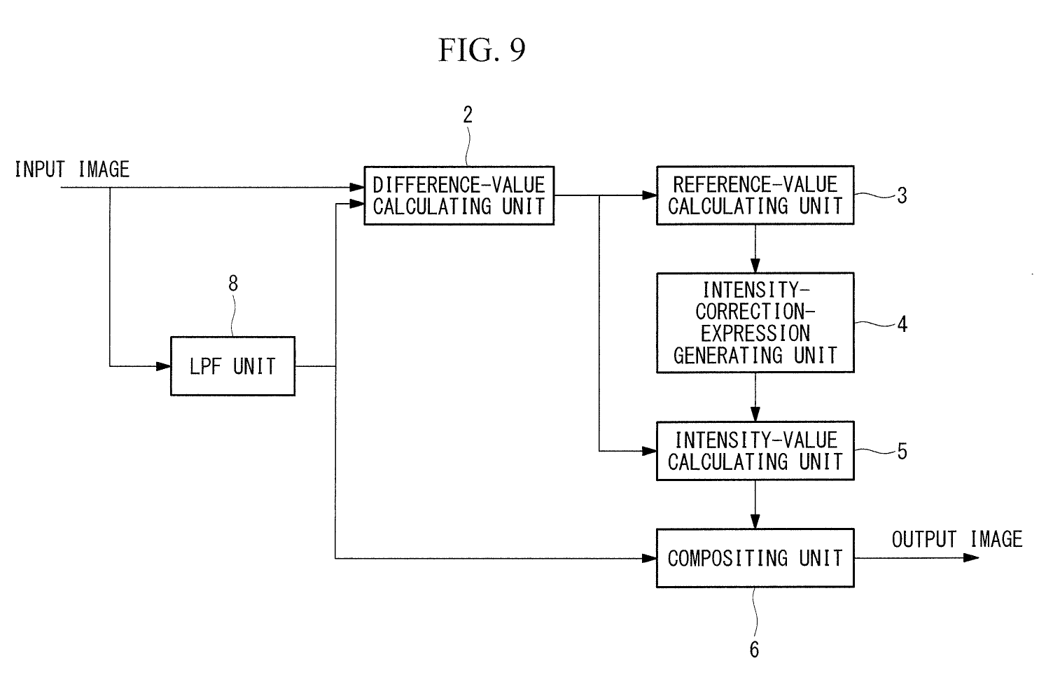

In this modification, as shown in FIG. 9, the image processing device includes an LPF unit 8 that applies low-pass-filter processing to an input image, an image processed by the LPF unit 8 is input to the difference-value calculating unit 2, and the difference-value calculating unit 2 calculates the differences between the input image and the image obtained by applying the low-pass-filter processing to the input image, thereby calculating difference values.

Furthermore, the intensity-value calculating unit 5 calculates an intensity value by adding the difference value and a weighting coefficient that is obtained from an intensity correction expression generated by the intensity-correction-expression generating unit, according to the following mathematical expression (11). Note that the weighting coefficient is calculated on the basis of the above-described mathematical expression (7) and mathematical expression (8).

Add(x,y)=(|edge(x,y)|+lim_max)×weight (weight>0)

Add(x,y)=((|edge(x,y)|+lim_min)×weight)×(−1) (weight<0) (11)

Since the processing of the reference-value calculating unit 3, the intensity-correction-expression generating unit 4, the intensity-value calculating unit 5, and the compositing unit 6 is the same as the processing in the above-described image processing device, a description thereof will be omitted.

Note that the compositing unit 6 adds the intensity values to the respective pixels of the image obtained after the low-pass-filter processing is performed by the LPF unit 8, thereby generating a composited image. Specifically, the composited image is generated according to the following mathematical expression (12).

out(x,y)=In_lpf(x,y)+Add(x,y) (12)

In this way, calculations of difference values etc. are performed by using an image obtained by applying low-pass-filter processing to an input image, thereby making it possible to perform more natural edge enhancement without significantly changing the frequency characteristic.

Note that it is also possible to cause a dedicated or general-purpose computer to execute, as an image processing program, the image processing performed in the above-described embodiment and modifications thereof.

According to one aspect, the present invention provides an image processing device including: a difference-value calculating means that calculates, with respect to an input image, a difference value for each pixel on the basis of a pixel of interest and surrounding pixels surrounding the pixel of interest serving as the center; a reference-value calculating means that calculates a reference value that serves as a reference used when an intensity value for each pixel of the input image is calculated, on the basis of the average value of the difference values; an intensity-correction-expression generating means that generates an intensity correction expression for calculating the intensity value, by using the reference value; an intensity-value calculating means that calculates an intensity value for each pixel on the basis of the intensity correction expression; and a compositing means that generates a composited image by adding the intensity values to the pixel values of the corresponding pixels of the input image.

As a result, the above-described embodiment leads to the following aspects.

According to the present invention, with respect to an input image, a difference value is calculated for each pixel on the basis of a pixel of interest and surrounding pixels surrounding the pixel of interest serving as the center, and a reference value is calculated on the basis of the average value of the difference values. Here, the reference value is a value that serves as a reference used when an intensity value for each pixel of the input image is calculated. Then, an intensity correction expression is generated by using the calculated reference value, the intensity value is calculated for each pixel on the basis of the intensity correction expression, and a composited image is generated by adding the obtained intensity values to the pixel values of the corresponding pixels of the input image.

In this case, the difference value is calculated, thereby making it possible to grasp, from the magnitude of the difference value, the features of the input image, e.g., whether the pixel of interest is an edge, or whether there is an edge very close to the pixel of interest. Then, because the reference value, which serves as a reference used when an intensity value is calculated, is calculated on the basis of the average value of the difference values, and the intensity correction expression is generated on the basis of the reference time, it is possible to obtain a parameter for performing image processing according to the input image. Here, the intensity value is a value that is calculated, for each pixel, with respect to each pixel of the input image and that indicates the degree of strength for edge enhancement processing performed with respect to the input image. Therefore, the intensity values, which are calculated from the intensity correction expression generated in this way, are added, for respective pixels, to the corresponding pixel values of the input image, to generate a composited image, thereby making it possible to suppress edge discontinuities and unnatural edge enhancement and to obtain a good image in which edges are naturally enhanced.

In the above-described invention, it is preferred that the reference-value calculating means correct the reference value on the basis of at least one of: the amount of noise or the contrast value in the input image; and the amount of noise or the contrast value in a predetermined area of the input image.

By doing so, it is possible to perform image processing according to the amount of noise or the contrast value.

In the above-described invention, it is preferred that the reference-value calculating means correct the reference value on the basis of at least one of the size of the input image and ISO sensitivity information obtained when the input image is acquired.

By doing so, it is possible to perform image processing according to the input image.

In the above-described invention, it is preferred that the intensity-correction-expression generating means generate an intensity correction expression for reducing the intensity value as the difference value becomes less than the reference value and reducing the intensity value as the difference value becomes greater than the reference value.

By doing so, it is possible to calculate the intensity value for performing image processing suitable for both of pixels at which edge enhancement should be performed and pixels at which edge enhancement is not preferable, according to the input image.

In the above-described invention, it is preferred that the input image be an image obtained by applying processing using a low-pass filter to the original image.

By doing so, it is possible to favorably enhance edges while preserving the high frequency and maintaining the properties thereof.

Furthermore, according to another aspect, the present invention provides an image processing method including: difference-value calculating step of calculating, with respect to an input image, a difference value for each pixel on the basis of a pixel of interest and surrounding pixels surrounding the pixel of interest serving as the center; a reference-value calculating step of calculating a reference value that serves as a reference used when an intensity value for each pixel of the input image is calculated, on the basis of the average value of the difference values; an intensity-correction-expression generating step of generating an intensity correction expression for calculating the intensity value, by using the reference value; an intensity-value calculating step of calculating the intensity value for each pixel on the basis of the intensity correction expression; and a compositing step of generating a composited image by adding the intensity values to the pixel values of the corresponding pixels of the input image.

Furthermore, according to still another aspect, the present invention provides an image processing program for causing a computer to execute: a difference-value calculating step of calculating, with respect to an input image, a difference value for each pixel on the basis of a pixel of interest and surrounding pixels surrounding the pixel of interest serving as the center; a reference-value calculating step of calculating a reference value that serves as a reference used when an intensity value for each pixel of the input image is calculated, on the basis of the average value of the difference values; an intensity-correction-expression generating step of generating an intensity correction expression for calculating the intensity value, by using the reference value; an intensity-value calculating step of calculating the intensity value for each pixel on the basis of the intensity correction expression; and a compositing step of generating a composited image by adding the intensity values to the pixel values of the corresponding pixels of the input image.

According to the present invention, an advantageous effect is afforded in that a good image in which edges are naturally enhanced can be obtained by suppressing edge discontinuities and unnatural edge enhancement.

### REFERENCE SIGNS LIST

2 difference-value calculating unit
3 reference-value calculating unit
4 intensity-correction-expression generating unit
5 intensity-value calculating unit
6 compositing unit
7 pre-processing unit
8 LPF unit

1. An image processing device comprising:
a difference-value calculating unit that is configured to calculate, with respect to an input image, a difference value for each pixel based on a pixel of interest and surrounding pixels surrounding the pixel of interest serving as the center;
a reference-value calculating unit that is configured to calculate a reference value that serves as a reference used when an intensity value for each pixel of the input image is calculated, based on the average value of the difference values;
an intensity-correction-expression generating unit that is configured to generate an intensity correction expression for calculating the intensity value, by using the reference value;
an intensity-value calculating unit that is configured to calculate the intensity value for each pixel on the basis of the intensity correction expression; and
a compositing unit that is configured to generate a composited image by adding the intensity values to pixel values of corresponding pixels of the input image.

2. An image processing device according to claim 1, wherein the reference-value calculating unit is configured to correct the reference value based on at least one of: the amount of noise or a contrast value in the input image; and the amount of noise or the contrast value in a predetermined area of the input image.

3. An image processing device according to claim 1, wherein the reference-value calculating unit is configured to correct the reference value based on at least one of a size of the input image and ISO sensitivity information obtained when the input image is acquired.

4. An image processing device according to claim 1, wherein the intensity-correction-expression generating unit is configured to generate an intensity correction expression for reducing the intensity value as the difference value becomes less than the reference value and reducing the intensity value as the difference value becomes greater than the reference value.

5. An image processing device according to claim 1, wherein the input image is an image obtained by applying processing using a low-pass filter to an original image.

6. An image processing method comprising:
calculating, with respect to an input image, a difference value for each pixel based on a pixel of interest and surrounding pixels surrounding the pixel of interest serving as the center;
calculating a reference value that serves as a reference used when an intensity value for each pixel of the input image is calculated, based on an average value of the difference values;
generating an intensity correction expression for calculating the intensity value, by using the reference value;
calculating the intensity value for each pixel based on the intensity correction expression; and
generating a composited image by adding the intensity values to pixel values of corresponding pixels of the input image.

7. A non-transitory computer-readable medium storing an image processing program for causing a computer to execute:
calculating, with respect to an input image, a difference value for each pixel based on a pixel of interest and surrounding pixels surrounding the pixel of interest serving as the center;
calculating a reference value that serves as a reference used when an intensity value for each pixel of the input image is calculated, based on an average value of the difference values;
generating an intensity correction expression for calculating the intensity value, by using the reference value;
calculating the intensity value for each pixel based on the intensity correction expression; and
generating a composited image by adding the intensity values to pixel values of corresponding pixels of the input image.
